(19) United States
(12) Patent Application Publication
(10) Pub. No.: US 2025/0163533 A1
(43) Pub. Date: May 22, 2025

(54) NON-ORIENTED ELECTRICAL STEEL SHEET AND MANUFACTURING METHOD THEREFOR

(71) Applicant: Hyundai Steel Company, Incheon (KR)

(72) Inventors: Han Hyuk Cho, Incheon (KR); Chun Ku Kang, Incheon (KR)

(21) Appl. No.: 19/034,864

(22) Filed: Jan. 23, 2025

Related U.S. Application Data
(63) Continuation of application No. PCT/KR2022/010421, filed on Jul. 19, 2023.

(30) Foreign Application Priority Data
Jul. 27, 2022 (KR) 10-2022-0093291

(51) Int. Cl. C21D 9/46; C21D 8/12; C22C 38/00; C22C 38/02; C22C 38/04; C22C 38/06

(52) U.S. Cl. CPC C21D 9/46; C21D 8/1222; C21D 8/1233; C21D 8/1238; C21D 8/1272; C22C 38/002; C22C 38/02; C22C 38/04; C22C 38/06

(57) ABSTRACT

Provided is a non-oriented electrical steel sheet including carbon (C): more than 0 wt % and not more than 0.003 wt %, silicon (Si): 2.0 wt % to 4.0 wt %, manganese (Mn): 0.1 wt % to 0.5 wt %, aluminum (Al): 0.3 wt % to 0.9 wt %, phosphorus (P): more than 0 wt % and not more than 0.015 wt %, sulfur (S): more than 0 wt % and not more than 0.003 wt %, nitrogen (N): more than 0 wt % and not more than 0.003 wt %, titanium (Ti): more than 0 wt % and not more than 0.003 wt %, and a balance of iron (Fe) and other unavoidable impurities, wherein a final microstructure of the non-oriented electrical steel sheet satisfies Inequality 1:

$$Inequality 1 : 0.00172 [ A ] - 0.0266 [ B ] < 2.0$$

(where [A] represents an average number of second-phase particles in a steel sheet cross-section with an area of 10×10 mm², and [B] represents a volume fraction value (unit: %) of particles with an average size of 2 μm or more among the second-phase particles.)

### CROSS-REFERENCE TO RELATED APPLICATIONS

This application is a continuation of International Application No. PCT/KR2022/010421 filed on Jul. 19, 2023, which claims under 35 U.S.C. § 119 (a) the benefit of Korean Patent Application No. 10-2022-0093291 filed on Jul. 27, 2022, the entire contents of which applications are incorporated by reference herein.

### FIELD

The present disclosure relates to a non-oriented electrical steel sheet and a method of manufacturing the same, and more particularly, to a non-oriented electrical steel sheet with improved magnetic properties and a method of manufacturing the same.

### BACKGROUND

Electrical steel sheets may be classified into oriented electrical steel sheets and non-oriented electrical steel sheets depending on their magnetic properties. Oriented electrical steel sheets exhibit excellent magnetic properties particularly in the rolling direction of the steel sheets because they are produced to be easily magnetized in the rolling direction, and thus are mostly used as cores for large, medium, and small-sized transformers which require low core loss and high magnetic permeability. On the other hand, non-oriented electrical steel sheets have uniform magnetic properties regardless of the direction of the steel sheets, and thus are commonly used as core materials for small motors, small power transformers, stabilizers, etc. Currently, in line with the trend of improving the efficiency and reducing the size of electrical devices to enhance energy savings, research is being conducted on minimizing core losses in non-oriented electrical steel sheets. For example, due to regulations aimed at reducing carbon dioxide (CO₂) emissions to combat global warming, existing internal combustion engine vehicles are being rapidly replaced by electric vehicles (EVs). Because EVs generate high torque during low-speed or acceleration conditions and operate at high rotational speeds (e.g., 200 Hz or higher) during constant-speed or high-speed driving, non-oriented electrical steel sheets used as motor core materials need to satisfy both high magnetic flux density and low core loss.

### SUMMARY

The present invention provides a non-oriented electrical steel sheet satisfying both high magnetic flux density and low core loss.

However, the above description is an example, and the scope of the present invention is not limited thereto.

According to an aspect of the present disclosure, there is provided a non-oriented electrical steel sheet comprising, consisting essentially of or consisting of carbon (C): more than 0 wt % and not more than 0.003 wt %, silicon (Si): 2.0 wt % to 4.0 wt %, manganese (Mn): 0.1 wt % to 0.5 wt %, aluminum (Al): 0.3 wt % to 0.9 wt %, phosphorus (P): more than 0 wt % and not more than 0.015 wt %, sulfur (S): more than 0 wt % and not more than 0.003 wt %, nitrogen (N): more than 0 wt % and not more than 0.003 wt %, titanium (Ti): more than 0 wt % and not more than 0.003 wt %, and a balance of iron (Fe) and other unavoidable impurities, wherein a final microstructure of the non-oriented electrical steel sheet satisfies the following Inequality 1:

$$Inequality 1 : 0.00172 [ A ] - 0.0266 [ B ] < 2.0$$

(where [A] represents an average number of second-phase particles in a steel sheet cross-section with an area of 10×10 mm², and [B] represents a volume fraction value (unit: %) of particles with an average size of 2 μm or more among the second-phase particles.)

In aspects, suitably the electrical steel sheet may have for example a thickness of 0.25 mm to 0.35 mm, a magnetic flux density (B₅₀) of 1.66 T or more, and a core loss (W_{10/400}) of 12.5 W/kg or less.

In aspects, the non-oriented electrical steel sheet suitably may have an average grain diameter of 80 μm to 150 μm.

According to another aspect of the present disclosure, there is provided a method of manufacturing a non-oriented electrical steel sheet, the method comprising, consisting essentially of or consisting of: (a) providing a steel material comprising, consisting essentially of or consisting of carbon (C): more than 0 wt % and not more than 0.003 wt %, silicon (Si): 2.0 wt % to 4.0 wt %, manganese (Mn): 0.1 wt % to 0.5 wt %, aluminum (Al): 0.3 wt % to 0.9 wt %, phosphorus (P): more than 0 wt % and not more than 0.015 wt %, sulfur (S): more than 0 wt % and not more than 0.003 wt %, nitrogen (N): more than 0 wt % and not more than 0.003 wt %, titanium (Ti): more than 0 wt % and not more than 0.003 wt %, and a balance of iron (Fe) and other unavoidable impurities; (b) hot rolling the steel material; (c) preliminarily annealing the hot-rolled steel material in a coiled state without cooling to room temperature after coiling; (d) cold rolling the preliminarily annealed steel material; and (e) cold annealing the cold-rolled steel material.

(C) may include performing coiling at a coiling temperature (CT) of 550° C. to 650° C., and performing annealing at 850° C. to 950° C. for 10 hours to 30 hours.

In aspects, the preliminary annealing suitably may be performed in a batch annealing furnace (BAF) instead of an annealing and pickling line (APL).

In aspects, the hot rolling suitably may include reheating the steel material for example under a slab reheating temperature (SRT) condition of 1110° C. to 1150° C., and hot rolling the steel material suitably under a finishing delivery temperature (FDT) condition of 860° C. to 900° C.

In aspects, the cold annealing may include performing annealing under conditions of a heating rate: 10° C./s or more, an annealing temperature: 900° C. to 1100° C., and a holding time: 30 sec. to 120 sec., and performing cooling under a condition of a cooling rate: 20° C./s or more.

A final microstructure obtained after performing (a) to (e) satisfies the following Inequality 1:

$$Inequality 1 : 0.00172 [ A ] - 0.0266 [ B ] < 2.0$$

(where [A] represents an average number of second-phase particles in a steel sheet cross-section with an area of 10×10 mm², and [B] represents a volume fraction value (unit: %) of particles with an average size of 2 μm or more among the second-phase particles.)

According to an embodiment of the present disclosure, a non-oriented electrical steel sheet satisfying both high magnetic flux density and low core loss, and a method of manufacturing the same may be provided.

However, the scope of the present disclosure is not limited to the above effects.

As referred to herein, second-phase particles can include without limitation inclusions, carbides, nitrides, carbonitrides, borides and/or oxides and other non-metallic particles and precipitates.

Core loss values as referred to herein suitably may be determined by testing a sample of steel using the Epstein test method to determine its core loss under specified conditions of magnetic flux density and frequency, usually following standards set by ASTM (American Society for Testing and Materials) such as ASTM A683-16.

As referred to herein magnetic density flux of a steel sheet or material refers to the strength of the magnetic field within a steel material, measured in Tesla (T). A gaussmeter suitably may be used to magnetic density flux of a steel sheet or material.

### BRIEF DESCRIPTION OF THE DRAWINGS

FIG. 1 is a flowchart of a method of manufacturing a non-oriented electrical steel sheet, according to an embodiment of the present disclosure.

### DETAILED DESCRIPTION

A non-oriented electrical steel sheet and a method of manufacturing the same, according to an embodiment of the present disclosure, will now be described in detail. The terms used herein are selected based on their functions in the present disclosure, and their definitions should be made in the context of the entire specification.

In general, factors such as chemical composition, steel sheet thickness, microstructure, insulating coating layer, and texture influence the magnetic properties of non-oriented electrical steel sheets. These various factors are influenced by process conditions for manufacturing non-oriented electrical steel sheets. Non-oriented electrical steel sheets are manufactured through steelmaking/continuous casting→hot rolling→heat treatment→cold rolling→heat treatment and coating, and the process conditions may be individually optimized to manufacture electrical steel sheets with excellent magnetic properties.

Non-oriented electrical steel sheets are commonly used as materials for transformers and rotating machines such as motors. Currently, due to environmental issues, demand for environmental preservation and improved energy efficiency is increasing. Particularly, the automotive industry is transitioning from internal combustion engine vehicles to electric vehicles (EVs) and hybrid electric vehicles (HEVs), and there is a growing demand to improve the magnetic properties of non-oriented electrical steel sheets to enhance the efficiency of EV motors. Non-oriented electrical steel sheets are required to exhibit magnetic properties of high magnetic flux density and low core loss.

To reduce the core loss of non-oriented electrical steel sheets, the thickness of the steel sheets needs to be reduced or the resistivity of the steel sheets needs to be increased. To reduce the thickness of the steel sheets, advanced manufacturing technology is required and a decrease in productivity is caused during the process. Also, the costs for processing and lamination in motor cores production increase. To increase the resistivity of the steel sheets, high-alloying elements such as silicon (Si), aluminum (Al), and manganese (Mn) may be added. However, the addition of such alloying elements complicates cold rolling. For example, in a normal electrical steel sheet process, when the content of Si exceeds 3.5 wt %, fractures occur during cold rolling and thus component control is required. In a non-oriented electrical steel sheet process, when the content of Si is greater than 3.5 wt %, the resistivity may not exceed 60μΩ·cm.

To meet high magnetic flux density and low core loss required for non-oriented electrical steel sheets for high-efficiency EVs and to increase resistivity, optimal alloy control and advanced processing technology are needed.

In terms of optimal alloy control, Si, Al, and Mn are major alloying elements used to increase resistivity. In addition to the above-mentioned elements, elements capable of improving cold rollability, e.g., chromium (Cr), copper (Cu), and nickel (Ni), are also being considered. However, such elements change magnetic and mechanical properties, and thus optimal conditions may not be easily found.

In terms of non-oriented electrical steel sheet manufacturing process, it is known that an annealing and pickling line (APL) process is essential to achieve high magnetic flux density and low core loss in a non-oriented electrical steel sheet containing more than 3% Si. Although the texture may be improved by controlling a heating rate, the magnetic properties deteriorate due to microstructural non-uniformity and thus microstructural control of a hot-rolled structure is essential starting from APL which is an intermediate process.

In the present disclosure, a non-oriented electrical steel sheet capable of achieving high magnetic flux density and low core loss by controlling the microstructure of a hot-annealed material through mass-produceable process conditions, and a method of manufacturing the same will be described.

A non-oriented electrical steel sheet with improved magnetic properties and a method of manufacturing the same will now be described in detail.

### Steel Sheet

A non-oriented electrical steel sheet according to an embodiment of the present disclosure includes carbon (C): more than 0 wt % and not more than 0.003 wt %, silicon (Si): 2.0 wt % to 4.0 wt %, manganese (Mn): 0.1 wt % to 0.5 wt %, aluminum (Al): 0.3 wt % to 0.9 wt %, phosphorus (P): more than 0 wt % and not more than 0.015 wt %, sulfur (S): more than 0 wt % and not more than 0.003 wt %, nitrogen (N): more than 0 wt % and not more than 0.003 wt %, titanium (Ti): more than 0 wt % and not more than 0.003 wt %, and a balance of iron (Fe) and other unavoidable impurities. The functions and contents of the components included in the non-oriented electrical steel sheet will now be described.

C: More than 0 wt % and not More than 0.003 wt %

C is an element for increasing core loss by forming carbides such as TiC and NbC, and the less the better. The content of C is limited to 0.003 wt % or less. When the content of C is greater than 0.003 wt %, magnetic aging occurs to deteriorate the magnetic properties, and when the content of C is 0.003 wt % or less, magnetic aging is suppressed.

### Si: 2.0 wt % to 4.0 wt %

Si is a major element added as a component for reducing eddy current loss by increasing resistivity. When the content of Si is less than 2.0 wt %, a desired low core loss value is not easily achieved, and when the content increases, the magnetic permeability and magnetic flux density decrease. When the content of Si is greater than 4.0 wt %, brittleness increases to cause difficulties in cold rolling and reduce productivity

### Mn: 0.1 wt % to 0.5 wt %

Mn increases resistivity together with Si and improves texture. When the content of Mn is less than 0.1 wt %, fine MnS precipitates are formed to suppress grain growth, and when Mn is added more than 0.5 wt %, coarse MnS precipitates are formed to cause a deterioration in magnetic properties, such as a decrease in magnetic flux density. Furthermore, when the content of Mn is greater than 0.5 wt %, the decrease in core loss is small compared to the amount added, and cold rollability significantly deteriorates.

### Al: 0.3 wt % to 0.9 wt %

Al is a major element added as a component for reducing eddy current loss by increasing resistivity together with Si. Al induces AlN precipitation when combined with N. When the content of Al is less than 0.3 wt %, the above-described effect may not be easily expected, and when the content of Al is greater than 0.9 wt %, cold rollability deteriorates, and the magnetic flux density is reduced to deteriorate the magnetic properties.

P: More than 0 wt % and not More than 0.015 wt %

P is an element for developing texture as a grain boundary segregation element. When the content of P is greater than 0.015 wt %, grain growth is suppressed, the magnetic properties deteriorate, and cold rollability is reduced due to the segregation effect.

S: More than 0 wt % and not More than 0.003 wt %

S increases core loss and suppresses grain growth by forming precipitates such as MnS and CuS, and thus the less the better. The content of S is limited to 0.003 wt % or less. When the content of S is greater than 0.003 wt %, the core loss increases.

N: More than 0 wt % and not More than 0.003 wt %

N increases core loss and suppresses grain growth by forming precipitates such as AlN, TIN, and NbN, and thus the less the better. The content of N is limited to 0.003 wt % or less. When the content of N is greater than 0.003 wt %, the core loss increases.

Ti: More than 0 wt % and not More than 0.003 wt %

Ti suppresses grain growth by forming fine precipitates such as TiC and TiN. Ti deteriorates the magnetic properties, and thus the less the better. The content of Ti is limited to 0.003 wt % or less. When the content of Ti is greater than 0.003 wt %, the magnetic properties deteriorate.

The final microstructure of the non-oriented electrical steel sheet according to an embodiment of the present disclosure with the above-described composition of alloying elements satisfies Inequality 1.

$$Inequality 1 : 0.00172 [ A ] - 0.0266 [ B ] < 2.0 ,$$

where [A] represents an average number of second-phase particles in a steel sheet cross-section with an area of 10×10 mm², and [B] represents a volume fraction value (unit: %) of particles with an average size of 2 μm or more among the second-phase particles. In the final microstructure, the second-phase particles may include inclusion particles and/or precipitate particles.

The non-oriented electrical steel sheet according to an embodiment of the present disclosure with the above-described composition may have a thickness of 0.25 mm to 0.35 mm, a magnetic flux density (B₅₀) of 1.66 T or more, and a core loss (W_{10/400}) of 12.5 W/kg or less. The non-oriented electrical steel sheet may have an average grain diameter of 80 μm to 150 μm. The non-oriented electrical steel sheet may also have mechanical properties of a yield point (YP): 400 MPa or more and a tensile strength (TS): 500 MPa or more.

A method of manufacturing the non-oriented electrical steel sheet according to an embodiment of the present disclosure with the above-described composition and properties will now be described.

### Method of Manufacturing Non-oriented Electrical Steel Sheet

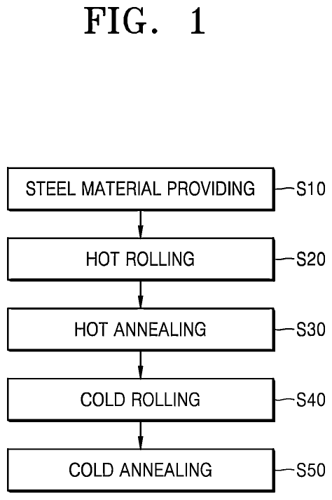

FIG. 1 is a flowchart of a method of manufacturing a non-oriented electrical steel sheet, according to an embodiment of the present disclosure.

Referring to FIG. 1, the non-oriented electrical steel sheet manufacturing method according to an embodiment of the present disclosure includes (a) providing a steel material consisting of C: more than 0 wt % and not more than 0.003 wt %, Si: 2.0 wt % to 4.0 wt %, Mn: 0.1 wt % to 0.5 wt %, Al: 0.3 wt % to 0.9 wt %, P: more than 0 wt % and not more than 0.015 wt %, S: more than 0 wt % and not more than 0.003 wt %, N: more than 0 wt % and not more than 0.003 wt %, Ti: more than 0 wt % and not more than 0.003 wt %, and a balance of Fe and other unavoidable impurities (S10); (b) hot rolling the steel material (S20); (c) preliminarily annealing the hot-rolled steel material in a coiled state without cooling to room temperature after coiling (S30); (d) cold rolling the preliminarily annealed steel material (S40); and (e) cold annealing the cold-rolled steel material (S50).

In the step of providing the steel material (S10), the composition of the steel material has been described in detail above. The steel material may have the shape of a slab.

The step of hot rolling the steel material (S20) may include reheating the steel material under a slab reheating temperature (SRT) condition of 1110° C. to 1150° C., and hot rolling the steel material under a finishing delivery temperature (FDT) condition of 860° C. to 900° C.

When the SRT is higher than 1150° C., precipitates such as C, S, and N in the slab may be redissolved and fine precipitates may be formed in subsequent rolling and annealing processes to suppress grain growth and deteriorate the magnetic properties. When the SRT is lower than 1110° C., the rolling load may increase.

The hot-rolled steel material may have a thickness of 1.8 mm to 2.6 mm. Because a reduction ratio of cold rolling increases and texture deteriorates when the hot-rolled plate is thick, the thickness may be controlled to 2.6 mm or less.

The step of preliminarily annealing the hot-rolled steel material in a coiled state without cooling to room temperature after coiling (S30) may include performing coiling at a coiling temperature (CT) of 550° C. to 650° C., and performing annealing at 850° C. to 950° C. for 10 hours to 30 hours. After the annealing, the steel sheet is cooled to room temperature. Before the subsequent cold rolling process, an oxide layer formed on the surface of the steel sheet cooled to room temperature is removed using a pickling solution.

When the CT is lower than 550° C., recovery and recrystallization are not sufficient, and dislocation density and accumulated energy are excessively high, and when the CT is higher than 650° C., excessive oxidation occurs during cooling due to high Si, Al, and Mn contents and thus pickability may deteriorate. In addition, recovery and recrystallization occur sufficiently, and dislocation density and accumulated energy are reduced, thereby causing microstructure and texture deterioration after APL.

When batch annealing furnace (BAF) annealing is performed after coiling and cooling to room temperature, a large quantity of fine precipitates are formed at low temperature during cooling to room temperature after coiling, which affects subsequent processes and deteriorates the magnetic properties. Meanwhile, when BAF annealing is performed without cooling to room temperature after coiling, a high rate of coarse precipitates is expected because the annealing is done before fine precipitates are formed.

Meanwhile, when the annealing temperature is lower than 850° C. or when the annealing temperature is in the appropriate range of 850° C. to 950° C. but the annealing time is shorter than 10 hours, fine inclusions such as carbides and nitrides are formed from the surface layer of the steel sheet, and the inclusions do not grow sufficiently to deteriorate the magnetic properties of the final product. In addition, the insufficient grain growth causes the formation of fine grains and thus the magnetic properties of the final product deteriorate.

On the other hand, when the annealing temperature is higher than 950° C. or when the annealing temperature is in the appropriate range of 850° C. to 950° C. but the annealing time is longer than 30 hours, inclusions are not uniformly distributed, grains grow excessively to cause a significant grain size variation, and oxidation occurs extensively, thereby adversely affecting the final product.

Meanwhile, according to a comparative example of the present disclosure, an APL process for annealing and pickling a hot-rolled plate may include performing annealing under conditions of a heating rate: 20° C./s or more, an annealing temperature: 950° C. to 1100° C., and a holding time: 30 sec. to 120 sec., performing cooling under a condition of a cooling rate: 30° C./s or more, and performing pickling.

The non-oriented electrical steel sheet manufacturing method according to an embodiment of the present disclosure is characterized in that the preliminary annealing is performed in a batch annealing furnace (BAF) instead of a continuous annealing system for annealing and pickling (e.g., APL).

In the BAF process where the steel material is inserted into the furnace and processed in the coiled state, because the entire coil is heated simultaneously, material non-uniformity may occur due to a temperature difference between the inside and outside of the coil. Therefore, the temperature difference may be minimized by applying a relatively long heat treatment time. The BAF process may be performed in a 100% nitrogen atmosphere.

Meanwhile, the advantage of the BAF process is that heat treatment conditions, e.g., temperature and time, during heating, holding, and cold annealing processes may be optimized depending on desired properties, and that production costs and steel sheet oxidation may be reduced compared to a continuous annealing process (e.g., APL or ACL).

The cold rolling step (S40) may include performing cold rolling under a condition of a reduction ratio: 80% to 85%, and the cold-rolled steel material may have a thickness of 0.35 mm or less. The cold rolling process may include finally cold rolling the pickled hot-rolled plate to a thickness of 0.25 mm or more and 0.35 mm or less. To provide rollability, the plate temperature may be increased to 150° C. to 200° C. for warm rolling.

The cold annealing step (S50) is an annealing and coating line (ACL) process for finally annealing the cold-rolled plate, and may include performing annealing under conditions of a heating rate: 10° C./s or more, an annealing temperature: 900° C. to 1100° C., and a holding time: 30 sec. to 120 sec., and performing cooling under a condition of a cooling rate: 20° C./s or more.

The cold annealing is performed with the cold-rolled plate obtained after the cold rolling. A temperature capable of achieving an optimal grain size is applied in consideration of core loss reduction and mechanical properties. Heating is performed under a mixed atmosphere condition to prevent surface oxidation and nitrification in the cold annealing. The surface is further smoothed using a mixed atmosphere of nitrogen and hydrogen. When the cold annealing temperature is lower than 900° C., fine grains may be formed to increase hysteresis loss, and when the cold annealing temperature is higher than 1100° C., coarse grains may be formed to increase eddy current loss.

After the final annealing, a coating process may be performed to improve punchability and ensure insulation.

The final microstructure of the non-oriented electrical steel sheet manufactured by performing the above-described steps satisfies Inequality 1.

$$Inequality 1 : 0.00172 [ A ] - 0.0266 [ B ] < 2.0 ,$$

where [A] represents an average number of second-phase particles in a steel sheet cross-section with an area of 10×10 mm², and [B] represents a volume fraction value (unit: %) of particles with an average size of 2 μm or more among the second-phase particles. In the final microstructure, the second-phase particles may include inclusion particles and/or precipitate particles.

The non-oriented electrical steel sheet manufactured by performing the above-described steps may have a thickness of 0.25 mm to 0.35 mm, a magnetic flux density (B₅₀) of 1.66 T or more, and a core loss (W_{10/400}) of 12.5 W/kg or less. The non-oriented electrical steel sheet may have an average grain diameter of 80 μm to 150 μm. The non-oriented electrical steel sheet may also have mechanical properties of a YP: 400 MPa or more and a TS: 500 MPa or more.

### Test Examples

Test examples will now be described for better understanding of the present disclosure. However, the following test examples are merely to promote understanding of the present disclosure, and the present disclosure is not limited to thereto.

### 1. Composition of Samples

The present test examples provide samples with the alloying element composition (unit: wt %) of Table 1.

TABLE 1

| C | Si | Mn | Al | P | S | N | Ti | Bal. |
|---|---|---|---|---|---|---|---|---|
| 0.0019 | 3.31 | 0.32 | 0.77 | 0.0055 | 0.0015 | 0.0017 | 0.0012 | Fe |

Referring to Table 1, the composition of non-oriented electrical steel sheets according to the test examples satisfies C: more than 0 wt % and not more than 0.003 wt %, Si: 2.0 wt % to 4.0 wt %, Mn: 0.1 wt % to 0.5 wt %, Al: 0.3 wt % to 0.9 wt %, P: more than 0 wt % and not more than 0.015 wt %, S: more than 0 wt % and not more than 0.003 wt %, N: more than 0 wt % and not more than 0.003 wt %, Ti: more than 0 wt % and not more than 0.003 wt %, and a balance of Fe.

### 2. Process Conditions and Property Evaluation

Table 2 shows process conditions and properties in a method of manufacturing a non-oriented electrical steel sheet, according to test examples of the present disclosure. A slab with the composition of Table 1 was reheated to 1140° C. and hot-rolled under a condition of a FDT of 880° C., thereby producing a hot-rolled plate with a thickness of 2.0 mm. After the hot rolling, heat treatment was continuously performed under various temperature conditions of Table 2. Then, cold rolling was performed to produce a cold-rolled plate with a thickness of 0.25 mm, and final annealing was performed at 975° C. for 50 sec. Then, a coating process was performed to manufacture a final product. The final annealing was performed in a mixed atmosphere of 30% hydrogen and 70% nitrogen. In this case, a heating rate of 20° C./s and a cooling rate of 30° C./s were used. Meanwhile, the distribution of inclusions in the finally annealed material of each sample was observed. The magnetic properties of the final product were obtained by measuring and averaging core loss and magnetic flux density values in the L direction parallel to the rolling direction and the C direction perpendicular to the rolling direction using a single sheet tester (SST).

In Table 2, a Z value is a result of calculating 0.00172×[A]−0.0266×[B], where [A] serves as an indicator of a total number of inclusions in the finally annealed material and represents an average number of second-phase particles in a steel sheet cross-section with an area of 10×10 mm², and [B] serves as an indicator of a volume fraction of coarse inclusions and represents a volume fraction value (unit: %) of particles with an average size of 2 μm or more among the second-phase particles.

TABLE 2

| | Conditions of Hot-Rolled Plate | | | | Inclusions in | | Magnetic | |
|---|---|---|---|---|---|---|---|---|
| | Heat Treatment (S30) | | | | Finally | | Properties of | |
| | Heat | | | | Annealed | | Finally Annealed | |
| | Treatment | Annealing | Annealing | | Material | | Material | Z |
| Examples | Method | Temperature | Time | | [A] | [B] | W_{10/400} | Value |
| Test | BAF | 700 | 12 | h | 2497 | 29.1 | 13.8 | 3.52 |
| Example 1 | | | | | | | | |
| Test | BAF | 800 | 24 | h | 2003 | 30.8 | 13.2 | 2.63 |
| Example 2 | | | | | | | | |
| Test | BAF | 850 | 6 | h | 1911 | 41.7 | 12.7 | 2.18 |
| Example 3 | | | | | | | | |
| Test | BAF | 850 | 24 | h | 1764 | 46.3 | 12.3 | 1.80 |
| Example 4 | | | | | | | | |
| Test | BAF | 850 | 60 | h | 2150 | 56.1 | 13.0 | 2.21 |
| Example 5 | | | | | | | | |
| Test | BAF | 900 | 6 | h | 1992 | 42.5 | 12.8 | 2.30 |
| Example 6 | | | | | | | | |
| Test | BAF | 900 | 24 | h | 1531 | 56.7 | 11.9 | 1.13 |
| Example 7 | | | | | | | | |
| Test | BAF | 900 | 60 | h | 2088 | 47.3 | 12.9 | 2.33 |
| Example 8 | | | | | | | | |
| Test | BAF | 950 | 6 | h | 2011 | 43.9 | 12.8 | 2.29 |
| Example 9 | | | | | | | | |
| Test | BAF | 950 | 24 | h | 1806 | 47.3 | 12.3 | 1.85 |
| Example 10 | | | | | | | | |
| Test | BAF | 950 | 60 | h | 1834 | 40.2 | 12.9 | 2.09 |
| Example 11 | | | | | | | | |
| Test | BAF | 1000 | 24 | h | 2372 | 25.1 | 13.9 | 3.41 |
| Example 12 | | | | | | | | |

Test Examples 4, 7, and 10 according to embodiments of the present disclosure satisfy the annealing conditions of 850° C. to 950° C. and 10 hours to 30 hours in the BAF annealing step (S30) of FIG. 1. In this case, it is shown that the Z value is less than 2 and the core loss (W_{10/400}) is 12.5 W/kg or less.

On the other hand, Test Examples 1 and 2 fall below and do not satisfy the annealing temperature range of 850° C. to 950° C. in the BAF annealing step (S30) of FIG. 1, and Test Example 12 exceeds and does not satisfy the annealing temperature range of 850° C. to 950° C. in the BAF annealing step (S30) of FIG. 1. Meanwhile, Test Examples 3, 6, and 9 satisfy the annealing temperature range of 850° C. to 950° C. but fall below and do not satisfy the annealing time of 10 hours to 30 hours in the BAF annealing step (S30) of FIG. 1, and Test Examples 5, 8, and 11 satisfy the annealing temperature range of 850° C. to 950° C. but exceed and do not satisfy the annealing time of 10 hours to 30 hours in the BAF annealing step (S30) of FIG. 1.

In short, Test Examples 1, 2, 3, 5, 6, 8, 9, 11, and 12 exhibit higher average numbers of second-phase particles compared to the embodiments (i.e., Test Examples 4, 7, and 10). In addition, Test Examples 1, 2, and 12, which do not satisfy the annealing temperature range of 850° C. to 950° C., exhibit lower volume fractions of particles with an average size of 2 μm or more among the second-phase particles compared to the embodiments (i.e., Test Examples 4, 7, and 10).

Test Examples 1, 2, 3, 5, 6, 8, 9, 11, and 12 according to comparative examples of the present disclosure exhibit a Z value greater than 2 and a core loss (W_{10/400}) greater than 12.5 W/kg.

For example, comparing Test Example 8 with Test Example 10, it is shown that, even though [B], which represents the volume fraction value of particles with an average size of 2 μm or more among the second-phase particles, is the same, when [A], which serves as an indicator of the number of inclusions in the finally annealed material and represents the average number of second-phase particles in a steel sheet cross-section with an area of 10×10 mm², is lower, the Z value drops below 2 and the core loss (W_{10/400}) is reduced.

Comparing Test Example 11 with Test Example 10, it is shown that, even though [A], which serves as an indicator of the number of inclusions in the finally annealed material and represents the average number of second-phase particles in a steel sheet cross-section with an area of 10×10 mm², is similar, when [B], which serves as an indicator of a volume fraction of coarse inclusions and represents the volume fraction value of particles with an average size of 2 μm or more among the second-phase particles, is higher, the Z value drops below 2 and the core loss (W_{10/400}) is reduced.

A non-oriented electrical steel sheet and a method of manufacturing the same, according to the technical features of the present disclosure, have been described above. The above description shows that, by performing a hot annealing process in a BAF instead of a continuous annealing system (e.g., APL) and appropriately controlling the temperature and holding time in the non-oriented electrical steel sheet manufacturing process, the microstructure may be controlled and the magnetic properties of the finally annealed material may be improved.

While the present disclosure has been particularly shown and described with reference to embodiments thereof, it will be understood by one of ordinary skill in the art that various changes in form and details may be made therein without departing from the scope of the present disclosure as defined by the following claims.

1. A non-oriented electrical steel sheet comprising carbon (C): more than 0 wt % and not more than 0.003 wt %, silicon (Si): 2.0 wt % to 4.0 wt %, manganese (Mn): 0.1 wt % to 0.5 wt %, aluminum (Al): 0.3 wt % to 0.9 wt %, phosphorus (P): more than 0 wt % and not more than 0.015 wt %, sulfur (S): more than 0 wt % and not more than 0.003 wt %, nitrogen (N): more than 0 wt % and not more than 0.003 wt %, titanium (Ti): more than 0 wt % and not more than 0.003 wt %, and a balance of iron (Fe) and other unavoidable impurities,
wherein a final microstructure of the non-oriented electrical steel sheet satisfies Inequality 1:
$$Inequality 1 : 0.00172 [ A ] - 0.0266 [ B ] < 2.0$$
(where [A] represents an average number of second-phase particles in a steel sheet cross-section with an area of 10×10 mm², and [B] represents a volume fraction value (unit: %) of particles with an average size of 2 μm or more among the second-phase particles.)

2. The non-oriented electrical steel sheet of claim 1, wherein the electrical steel sheet has a thickness of 0.25 mm to 0.35 mm, a magnetic flux density (B₅₀) of 1.66 T or more, and a core loss (W_{10/400}) of 12.5 W/kg or less.

3. The non-oriented electrical steel sheet of claim 1, wherein the non-oriented electrical steel sheet has an average grain diameter of 80 μm to 150 μm.

4. A method of manufacturing a non-oriented electrical steel sheet, the method comprising:
(a) providing a steel material consisting of carbon (C): more than 0 wt % and not more than 0.003 wt %, silicon (Si): 2.0 wt % to 4.0 wt %, manganese (Mn): 0.1 wt % to 0.5 wt %, aluminum (Al): 0.3 wt % to 0.9 wt %, phosphorus (P): more than 0 wt % and not more than 0.015 wt %, sulfur (S): more than 0 wt % and not more than 0.003 wt %, nitrogen (N): more than 0 wt % and not more than 0.003 wt %, titanium (Ti): more than 0 wt % and not more than 0.003 wt %, and a balance of iron (Fe) and other unavoidable impurities;
(b) hot rolling the steel material;
(c) preliminarily annealing the hot-rolled steel material in a coiled state without cooling to room temperature after coiling;
(d) cold rolling the preliminarily annealed steel material; and
(e) cold annealing the cold-rolled steel material.

5. The method of claim 4, wherein (c) comprises performing coiling at a coiling temperature (CT) of 550° C. to 650° C., and performing annealing at 850° C. to 950° C. for 10 hours to 30 hours.

6. The method of claim 4, wherein the preliminary annealing is performed in a batch annealing furnace (BAF) instead of an annealing and pickling line (APL).

7. The method of claim 4, wherein the hot rolling comprises reheating the steel material under a slab reheating temperature (SRT) condition of 1110° C. to 1150° C., and hot rolling the steel material under a finishing delivery temperature (FDT) condition of 860° C. to 900° C.

8. The method of claim 4, wherein the cold annealing comprises performing annealing under conditions of a heating rate: 10° C./s or more, an annealing temperature: 900° C. to 1100° C., and a holding time: 30 sec. to 120 sec., and performing cooling under a condition of a cooling rate: 20° C./s or more.

9. The method of claim 4, wherein a final microstructure obtained after performing (a) to (e) satisfies the following Inequality 1:
$$Inequality 1 : 0.00172 [ A ] - 0.0266 [ B ] < 2.0$$
(where [A] represents an average number of second-phase particles in a steel sheet cross-section with an area of 10×10 mm², and [B] represents a volume fraction value (unit: %) of particles with an average size of 2 μm or more among the second-phase particles.)
